(19) United States
(12) Patent Application Publication
(10) Pub. No.: US 2017/0044432 A1
(43) Pub. Date: Feb. 16, 2017

(54) CRYSTALLINE MATERIAL, PROCESS FOR PRODUCING IT AND USE THEREOF

(71) Applicant: Polysecure GmbH, Freiburg (DE)

(72) Inventors: Thomas BAQUE, Freiburg (DE); Jochen MOESSLEIN, Freiburg (DE)

(21) Appl. No.: 15/305,365

(22) PCT Filed: Apr. 24, 2015
(86) PCT No.: PCT/EP2015/058899

§ 371 Date: Oct. 20, 2016

(30) Foreign Application Priority Data
Apr. 25, 2014 (DE) 10 2014 105 846.1

(51) Int. Cl. C09K 11/77; C09D 11/50

(52) U.S. Cl. CPC C09K 11/7769; C09D 11/50; G01N 21/64

(57) ABSTRACT

The present invention relates to a crystalline material comprising a basic crystal based on at least one host element (We), which basic crystal is doped with at least one element of the rare earths (Do), the crystalline material having the formula:

We1₍ₐ₎We2_{(b)}Ta_{(c)}Do1_{(d)}Do2₍ₑ₎Hal_{(w)}O₍ₓ₎Te_{(y)}Se_{(z)}

### TECHNICAL FIELD

The present invention relates to a crystalline material, a process for producing it and uses thereof.

### BACKGROUND

Anti-Stokes crystals based on yttrium oxisulphide and gadolinium oxisulphide, doped with rare earths have been known for many years. These crystals are typically produced by means of solid-phase synthesis. When excited with IR radiation of a particular wavelength, they exhibit distinct luminescence. These crystals are used inter alia as marking agents for detecting forgeries.

The sulphur and its compounds contained in the crystals can easily be released as sulphur dioxide or hydrogen sulphide by acids and/or heating. Moist and warm ambient air is in some cases already sufficient to cause this. Because of the odour and physiological harmfulness of the sulphur compounds, it is impossible to use these substances in many applications. Examples here are everyday articles, food packaging, pharmaceutical and medical products.

Processes are described in WO 1998039392 A1 which make it possible to reduce the amount of sulphur. It was not, however, possible to dispense with it altogether.

Furthermore, because of the production process, a uniform particle size is not achieved. In order to achieve the maximum conversion of the IR radiation into visible light, however, it is desirable to have a uniform crystal with as few interfaces and defects as possible. The performance of the crystals produced in this way is therefore only moderate. The crystal size can only be adjusted within narrow limits, and in particular small crystals, such as those used in the manufacture of printing inks, inks, films and monofilaments, can only be achieved by grinding the crystals. Because of the procedure used, the crystals are broken down in the process, as a result of which their performance, especially the quantum yield, drops.

A further disadvantage of the process is that ultra-pure metal oxides have to be used in the synthesis. As a rule, oxides with a purity of 99.99999% (5-nine grade) are used. These are correspondingly expensive and in their availability they have to compete with the growing demand in the semiconductor and illumination industry.

It is a problem of the present invention to provide a crystalline material which overcomes the disadvantages of the state of the art, in particular is free of sulphur, can be manufactured in a simple manner and can be used as a marking agent, preferably exploiting an anti-Stokes effect of the crystalline material.

### SUMMARY

This problem is solved by a crystalline material comprising a basic crystal based on at least one host element (We), which basic crystal is doped with at least one element of the rare earths (Do), the crystalline material having the formula:

We1₍ₐ₎We2_{(b)}Ta_{(c)}Do1_{(d)}Do2₍ₑ₎Hal_{(w)}O₍ₓ₎Te_{(y)}Se_{(z)}

where We1 and We2 are independently and differently selected from elements from the group consisting of niobium, aluminium, scandium, barium, gadolinium, lanthanum, yttrium, cerium, calcium and titanium; Do1 and Do2 are independently and differently selected from elements of the group of rare earths; Hal is fluoride, chloride, bromide or iodide; the indices (a)-(z) each being 0 to 3 independently of one another, though at least one of (a) and (b) is greater than 0, at least one of (d) and (e) is greater than 0, and at least one of (w), (x), (y) and (z) is greater than 0; wherein the sum of (a)+(b)+(c)=1-2, preferably 1 or 2, and the sum of (w)+(x)+(y)+(z)=2-3, preferably 2 or 3, with the proviso that (c) is >0 if
We1=Ca, We2=Sc, Doi=Yb or Tm, and (e)=(w)=(y)=(z)=0, or
We1=Ce, Dol=Eu or Er and (b)=(e)=(w)=(y)=(z)=0.

It may preferably be contemplated that (c) is >0.

It is preferable that We1 and/or We2 is/are present in a +3 or +4, preferably +3, oxidation state.

It may particularly preferably be contemplated that (x) is >0. It is also preferable that (w)=(y)=(z)=0. Tellurium and selenium, if present, are likewise preferably present as tellurite or selenite. Preferred host elements are gadolinium and lanthanum, preferably in oxidic form. It is likewise preferable that (y)=(z)=0 and/or (b)=0 and/or (e)=0.

In a particularly preferred embodiment, the crystalline material of the invention does not comprise lanthanum fluoride (LaF₃), calcium fluoride (CaF₂) and/or yttrium fluoride (YF₃). In a likewise preferred embodiment, the crystalline material of the invention does not comprise any europium, especially no yttrium oxide doped with europium yttrium fluoride (YF₃). it is also preferable that the crystalline material does not contain any dysprosium (Dy).

It may also be contemplated that the basic crystal is doped with 0.5-10 per cent by weight rare-earth oxide, based on the total weight of the crystalline material

It is preferably contemplated that the rare-earth element is selected from erbium, ytterbium, thulium and holmium, preferably a combination of two rare-earth oxides, preferably erbium oxide and ytterbium oxide.

A further problem is solved by a process (sol-gel process) for producing a crystalline material of the invention, said process comprising the steps of: a) providing aqueous solutions of salts or oxides of the elements to be used, b) mixing the aqueous solutions from step a) in a desired ratio, c) adding an oxidising agent and a glycol and/or polyglycol to the mixture from step b), d) heating a mixture produced in step c) to a temperature of 50-150° C., preferably 60-120° C., to form a gel, e) heating the gel to a temperature of at least 175° C., preferably in a furnace, to convert the gel into a powder, f) annealing the powder obtained in step e) at a temperature of at least 500° C., preferably 500-2,000° C.

It may be contemplated in this connection that ethylene glycol, propylene glycol, their polycompounds and/or glycerol is/are used as the glycol or polyglycol.

It may also be contemplated that the oxidising agent is nitric acid or hydrogen peroxide.

It may further be preferably contemplated that the heating in step d) is performed for a period of 1-10 hours, preferably 3-7 hours, and/or the heating in step e) is performed for a period of 0.1-2 hours and/or the annealing in step f) is performed for a period of 1-24 hours.

It is preferably contemplated that the annealing in step f) is performed on the basis of a temperature-time gradient.

A further problem is solved by a process (hydro process) for producing a crystalline material of the invention, which process comprises the steps of: i) preparing aqueous solutions of the elements to be used in their nitrate form, ii) optionally accompanied by cooling and stirring, adding ammonium hydroxide, until no precipitate is deposited any longer, iii) rinsing the precipitate with water, iv) drying the precipitate obtained in step iii) and annealing at 600-1,700° C., preferably 1,000-1,300° C., for preferably 0.1-12 hours, even more preferably 0.25-1 hour.

If in this process the starting element compounds are not present in the form of their nitrate salts, but rather in oxidic form or as carbonates, those compounds can be reacted to their nitrates with nitric acid while being heated, preferably in a stirred tank. Then after the solution has cooled down, preferably accompanied by cooling and intensive stirring, ammonium hydroxide may be added until no precipitate is deposited any longer. The further procedure is then analogous to the steps described above.

The invention also relates to the use of the crystalline material as a marking agent for marking materials, especially technical products and components, everyday articles, food packaging, pharmaceuticals, medical products, luxury goods and security documents. Corresponding materials may, for example, comprise metals, plastics, glasses, etc.

It has surprisingly been found in accordance with the invention that the anti-Stokes crystals prepared are free of sulphur and, in their manufacture, solve the problems known from the state of the art, such as raw materials supplies. In addition, almost perfect crystals can be produced in a purposive manner in a wide range of sizes. The anti-Stokes crystals of the invention permit their use as marking agents for detecting forgeries; they may, for example, be used with no problems in many everyday articles, food packaging, pharmaceuticals and medical products.

If the basic crystals also contain tantalum, the luminance of the anti-Stokes crystal is improved still further.

The crystalline material of the invention is preferably an anti-Stokes crystal.

The advantage of the sol-gel process is that very fine crystals can be produced, whereas the hydro process, i.e. the reaction with nitric acid and ammonium hydroxide, has the advantage that it can be performed very quickly.

Further advantages and features of the crystalline material of the invention and its production process will become clear from the following general and detailed description, illustrated with reference to examples.

### DETAILED DESCRIPTION

The crystalline materials of the invention are produced in a first alternative in a modified sol-gel process. For this purpose, it is preferable for aqueous solutions of the nitrates of the elements to be mixed with glycols or polyglycols and an oxidising agent and heated.

After a few hours, the sol produced in this way turns into a gel. Because of their good solubility and easy synthesis, nitrates are preferable, but other salts of the elements may be used if needed.

In principle, all glycols or polyglycols can be used. Ethylene and propylene glycol and their polycompounds are preferred, however. Glycerol is likewise preferred.

As the oxidising agent, nitric acid is preferred, but other oxidising agents, such as hydrogen peroxide, are also suitable.

At temperatures of at least 175° C., with a highly exothermal reaction, the gel is converted into the oxide crystals of the starting substances. These are formed as a very fine, voluminous powder. That is then annealed at temperatures higher than 500° C. Depending on the time and temperature, crystals of different sizes are formed, which exhibit different decay times of the luminescence. The general rule is that the size of the crystal increases as the temperature and time increase.

### General Course of The Production of the Crystalline Materials According to the Sol-Gel Process

There are alternative ways of preparing the elements to be used for the production of the aqueous solutions, see 1.a and 1.b below.
1. Production of the solutions of the elements
   a. Nitrates of the elements were dissolved as a 1M solution in 1:4 diluted nitric acid. The purity of the compounds is preferably at least 99.94%.
   b. Oxides of the elements are dissolved, with heating, in nitric acid which is concentrated or diluted with water by up to 20%. In the process, the corresponding nitrates form. If necessary, the solution can be purified of unwanted substances or elements by physical (filtration, centrifugation, etc.) or chemical (e.g. precipitation) processes.
2. Production of the sol
   a. The nitric solutions of the element nitrates are mixed in the corresponding ratio.
   b. After that, 3-20% by weight glycol or polyglycol, based on the total weight of the solutions, is added. It is preferable to use ethylene glycol or low-molecular-weight polyethylene glycol. Alternatively, propylene glycol may also be used.
3. Formation of the gel
   a. The mixture is heated to a temperature of 60-90° C. accompanied by stirring and is kept at that temperature for several hours. In the process, the viscosity of the solution increases and a gel forms.
   b. After the desired viscosity has been reached, the gel is filled into dishes.
4. Oxidation
   a. The dishes filled with gel are placed in a furnace at a temperature of approx. 200° C. In the process, the remaining water first evaporates.
   b. After that, a powerful exothermal reaction begins. This leads to a distinct increase in the furnace temperature.
   c. Once the reaction has subsided, the fine powder formed is filled into crucibles of aluminium oxide.
5. Annealing process
   a. The crucibles are annealed in an annealing furnace at 500-2,000° C. The annealing time may be up to 24 hours. The invention also relates to the preferred use of a temperature-time gradient.
   b. As an alternative to batch annealing in the muffle furnace, it is also possible to perform a continuous annealing process in a continuous furnace or rotary kiln.
   c. After cooling, the powder is removed from the crucibles and if necessary crushed and sieved. For this purpose, standard processes used in chemical production are employed, with which the skilled person is familiar.

### General Course of the Production of the Crystalline Materials According to the Hydro Process

There are alternative ways of preparing the elements to be used for the production of the aqueous solutions, see 1.a and 1.b below.
1. Production of the solutions of the elements
   a. Nitrates of the elements were dissolved as a 1M solution in 1:4 diluted nitric acid. The purity of the compounds is preferably at least 99.9%.
   b. Oxides of the elements are dissolved, with heating, in nitric acid which is concentrated or diluted with water by up to 20%. In the process, the corresponding nitrates form. If necessary, the solution can be purified of unwanted substances or elements by physical (filtration, centrifugation, etc.) or chemical (e.g. precipitation) processes.
2. Formation of the hydroxides
   a. The nitric solutions of the element nitrates are mixed in the corresponding ratio.
   b. Accompanied by intensive stirring, preferably with a rotor-stator mixer (known as “Turax”) and cooling, concentrated aqueous ammonium hydroxide solution is added until the elements are completely precipitated.
   c. The hydroxides are rinsed several times with demineralised water in order to remove surplus ammonium hydroxide.
3. Separating and drying the hydroxide
   a. The precipitate is separated from the water by filtration or preferably centrifugation.
   b. Then the residue is dried to a residual moisture of 5%, preferably less than 1%. Processes for this purpose are known; preferred processes are spray-drying and microwave drying.
4. Annealing process
   a. The crucibles are annealed in an annealing furnace at 500-2,000° C. The annealing time may be up to 24 hours. The invention also relates to the preferred use of a temperature-time gradient.
   b. As an alternative to batch annealing in the muffle furnace, it is also possible to perform a continuous annealing process in a continuous furnace or rotary kiln.
   c. After cooling, the powder is removed from the crucibles and if necessary crushed and sieved. For this purpose, standard processes used in chemical production are employed, with which the skilled person is familiar.

### EXAMPLE 1

### Crystal Based on Cerium(IV)-Tantalum Oxide

20.3 g (0.06 mole) Ce(NO₃)₃ are prepared as a 1M solution in a 600 ml glass beaker. Then 30 ml concentrated nitric acid, 3 ml 1M Ta(NO₃)₃ and 5 ml 1M Er(NO₃)₃ solution are added. Accompanied by stirring and heating to 60° C., 120 ml, ethylene glycol are added. The solution is kept at 60° C. for 6 hours. In that time, the colour of the solution, which is originally pink, turns a deep red and the viscosity of the solution increases considerably. The gel is transferred to a shallow porcelain dish and left to stand overnight to dry.

The dish is placed in a muffle furnace at a temperature of approx. 200° C. After approx. 15 minutes, a sharp rise in temperature in the muffle furnace can be observed. After a further 15 minutes, the gel has changed into a fine white powder. That is transferred to an aluminium oxide crucible and subsequently annealed for 4 hours at 800° C.

The anti-Stokes effect can be detected as a distinct red luminescence with an excitation source of 980 nm.

### EXAMPLE 2

### Crystal Based on Calcium-Scandium-Tantalum Oxide

20 ml of a 1M Ca(NO₃)₂ solution are placed in a glass beaker with 20 ml 1M Sc(NO₃)₃ solution and 0.6 ml each of 1M Yb(NO₃)₃ and Er(NO₃)₃. 2 ml Ta(NO₃)₃ 1M solution, 100 ml water and 10 ml concentrated nitric acid are then added and heated for 30 min to 80° C. accompanied by stirring. Now, 40 g polyethylene glycol 400 and 0.5 ml glycerol are added. The temperature is raised to 120° C. After 4 hours, the reaction was stopped and the gel formed was transferred to a porcelain dish.

The dish is placed in a muffle furnace at a temperature of 200° C. After approx. 15 minutes, a sharp rise in temperature in the muffle furnace can be observed. After a further 15 minutes, the gel has changed into a fine white powder. Even here, luminescent crystals can be observed when excited at 980 nm.

The powder is transferred to an aluminium oxide crucible and subsequently annealed for 4 hours at 800° C.

The anti-Stokes effect can be detected as a distinct green luminescence with an excitation source of 980 nm.

### EXAMPLE 3

### Crystal Based on Gadolinium-Tantalum Oxide

28.8 g Gd₂O₃, 1.6 g Yb₂O₃ and 0.2 g Er₂O₃ are placed in a 600 ml Erlenmeyer flask. 60 ml concentrated nitric acid and 5 ml Ta(NO₃)₃ 1M solution are added. The substances are dissolved accompanied by stirring and heating to 90° C.

After the solution has cooled, aqueous 25% NH₄OH solution is added, accompanied by intensive stirring, until no further precipitation occurs. The precipitate is rinsed 3 times with the water and is then separated. After that, it is dried in a drying cabinet for 24 hours at 150° C.

The powder is transferred to an aluminium oxide crucible and subsequently annealed for 2 hours at 1,000° C.

The anti-Stokes effect can be detected as a distinct orange luminescence with an excitation source of 980 nm.

The crystalline materials produced in this way can be used as marking agents for marking materials in order to be able to distinguish genuine original products/materials from forgeries. The anti-Stokes effect, or the anti-Stokes fluorescence emitted, is used for this purpose. The use of anti-Stokes materials as marking agents is known in the art.

The features of the invention disclosed in the above description and in the claims can be essential to implementing the invention in its various embodiments both individually and in any combination.

1. A crystalline material comprising a basic crystal based on at least one host element (We), which basic crystal is doped with at least one element of the rare earths (Do), the crystalline material having the formula:
We1₍ₐ₎We2_{(b)}Ta_{(c)Do}1_{(d)}Do2₍ₑ₎Hal_{(w)}O₍ₓ₎Te_{(y)}Se_{(z)}
where We1 and We2 are independently and differently selected from elements from the group consisting of niobium, aluminium, scandium, barium, gadolinium, lanthanum, yttrium, cerium, calcium and titanium; Do1 and Do2 are independently and differently selected from elements of the group of rare earths; Hal is fluoride, chloride, bromide or iodide; the indices (a)-(z) each being 0 to 3 independently of one another, though at least one of (a) and (b) is greater than 0, at least one of (d) and (e) is greater than 0, and at least one of (w), (x), (y) and (z) is greater than 0; wherein the sum of (a)+(b)+(c)=1-2, preferably 1 or 2, and the sum of (w)+(x)+(y)+(z)=2-3, preferably 2 or 3, with the proviso that (c) is >0 if
We₁=Ca, We₂=Sc, Do₁=Yb or Tm and (e)=(w)=(y)=(z)=0, or
We₁=Ce, Do₁=Eu or Er and (b)=(e)=(w)=(y)=(z)=0.

2. The crystalline material as claimed in claim 1, characterised in that (c)>0.

3. The crystalline material as claimed in claim 1, characterised in that We₁ and/or We₂ is/are present in a +3 or +4, oxidation state.

4. The crystalline material as claimed in claim 1, characterised in that the basic crystal is doped with 0.5-10 per cent by weight rare-earth oxide, based on the total weight of the crystalline material.

5. The crystalline material as claimed in claim 1, characterised in that the rare-earth element is selected from erbium, ytterbium, thulium and holmium.

6. A process for producing a crystalline material as claimed in claim 1, said process comprising the steps of:
a) providing aqueous solutions of salts or oxides of the elements to be used,
b) mixing the aqueous solutions from step a) in a desired ratio,
c) adding an oxidising agent and a glycol and/or polyglycol to the mixture from step b),
d) heating a mixture produced in step c) to a temperature of 50-150° C., to form a gel,
e) heating the gel to a temperature of at least 175° C., to convert the gel into a powder.
f) annealing the powder obtained in step e) at a temperature of at least 500° C.

7. The process as claimed in claim 6, characterised in that ethylene glycol, propylene glycol, their polycompounds and/or glycerol is/are used as the glycol or polyglycol.

8. The process as claimed in claim 6, characterised in that the oxidising agent is nitric acid or hydrogen peroxide.

9. A process for producing a crystalline material as claimed in claim 1, said process comprising the steps of:
i) preparing aqueous solutions of the elements to be used in their nitrate form,
ii) optionally accompanied by cooling and stirring, adding ammonium hydroxide, until no precipitate is deposited any longer,
iii) rinsing the precipitate with water,
iv) drying the precipitate obtained in step iii) and annealing at 600-1,700° C.

10. A method for marking one or more materials, selected from technical products and components, everyday articles, food packaging, pharmaceuticals, medical products, luxury goods and security documents with marking agent selected from the crystalline material of claim 1.

11. The crystalline material as claimed in claim 2, characterised in that We₁ and/or We₂ is/are present in a +3 or +4 oxidation state.

12. The crystalline material as claimed in claim 2, characterised in that the basic crystal is doped with 0.5-10 per cent by weight rare-earth oxide, based on the total weight of the crystalline material.

13. The crystalline material as claimed in claim 3, characterised in that the basic crystal is doped with 0.5-10 per cent by weight rare-earth oxide, based on the total weight of the crystalline material.

14. The crystalline material as claimed in claim 1, characterised in that the rare-earth element is a combination of two rare-earth oxides.

15. The crystalline material as claimed in claim 1, characterised in that the rare-earth element is a combination of erbium oxide and ytterbium oxide.
